(19) United States
(12) Patent Application Publication
(10) Pub. No.: US 2026/0119852 A1
(43) Pub. Date: Apr. 30, 2026

(54) METHOD AND DEVICE FOR GENERATING AI RESPONSE USING PERSONAL DATA

(71) Applicant: SAMSUNG SDS CO., LTD., Seoul (KR)

(72) Inventors: Ju Seon HONG, Seoul (KR); Jae Hyuck JANG, Seoul (KR); Dae Gon KIM, Seoul (KR); Hye Mi SEO, Seoul (KR); Moo Young CHO, Seoul (KR)

(73) Assignee: SAMSUNG SDS CO., LTD., Seoul (KR)

(21) Appl. No.: 19/352,031

(22) Filed: Oct. 7, 2025

(30) Foreign Application Priority Data
Oct. 30, 2024 (KR) 10-2024-0150216

(51) Int. Cl. G06N 3/0475; G06N 3/042

(52) U.S. Cl. CPC G06N 3/0475; G06N 3/042

(57) ABSTRACT

Provided is a method and system for generating an AI-based response using personal data. Specifically, a method and system for generating the AI-based response related to a work on behalf of a user by transmitting a prompt related to work-related data to a generative AI model is proposed. Further, a method and system for generating a single AI-based response message to a combination of a plurality of messages is provided. In addition, a method and system for determining whether a generated AI-based response message is related to a received message is provided.

### CROSS-REFERENCE TO RELATED APPLICATION

This application claims priority from Korean Patent Application No. 10-2024-0150216 filed on Oct. 30, 2024 in the Korean Intellectual Property Office, and all the benefits accruing therefrom under 35 U.S.C. 119, the contents of which in its entirety are herein incorporated by reference.

### BACKGROUND

### Field

The present disclosure relates to a method and device for generating an AI-based response using personal data. Specifically, the present disclosure relates to a method and device for generating a response related to a work on behalf of a user by transmitting a prompt related to work-related data to a generative AI model.

### Description of Related Art

The generative AI model refers to an artificial neural network capable of generating new text, images, voices, and the like based on given data. The generative AI model may be used to automatically create various types of contents.

A chatbot using the generative AI model may provide an interactive service to answer a user's question or assist a work. Such chatbots are efficiently used in various fields such as customer support and information retrieval.

However, the current generative AI model performs machine learning based on general data. Therefore, the chatbot using the current generative AI model may lack accuracy related to a work requiring the latest information and a work requiring personal information. Therefore, it is requested to provide a chatbot using a generative AI model that may assist a specific individual's work.

### SUMMARY

A technical purpose to be achieved using some embodiments of the present disclosure is to provide a method for automatically generating a work-related response message on behalf of a user.

Another technical purpose to be achieved using some embodiments of the present disclosure is to provide a method for automatically generating a combined AI-based response message to a plurality of messages.

Still another technical purpose to be achieved using some embodiments of the present disclosure is to provide a method for generating an AI-based response related to a work and determining accuracy of the generated AI-based response.

The technical purposes to be achieved by the present disclosure are not limited to the technical purposes as mentioned above, and other technical purposes not mentioned may be clearly understood by those skilled in the art related to the present disclosure based on the following detailed descriptions.

According to an aspect of the present disclosure, there is provided a method for generating AI response using personal data. The method may comprise obtaining a first message having a first user as a recipient; generating a first message schedule indicating a generation time point of a response to the first message, based on an analysis result of the first message; and performing a process of automatically generating a response message to a response-requesting message set, at the generation time point of the response to the first message according to the first message schedule, wherein the response-requesting message set includes the first message and one or more additional messages, wherein the generation time point of the response to the first message may be a time point delayed by a reference value or larger from a time point at which the first message is acquired, wherein the process may include: retrieving information related to the one or more additional messages included in the response-requesting message set from work information database of an organization to which the first user belongs; automatically generating a first prompt to obtain a response to each of the one or more additional messages included in the response-requesting message set, wherein the first prompt includes the retrieved information; transmitting the first prompt to a generative artificial intelligence-based query-response service provider; and receiving the response message from the generative artificial intelligence-based query-response service provider in response to transmission of the first prompt.

In some embodiments, an update of information related to the first user has been applied to the work information database, at a time point between a time point at which the first message is acquired and the generation time point of the response to the first message.

In some embodiments, response-requesting message set may include a second message obtained from a sender of the first message.

In some embodiments, response-requesting message set may include a second message obtained from a sender different from the sender of the first message.

In some embodiments, performing of the process may include: checking presence of a response message to the first message from the first user at a time point between a time point at which the first message is obtained and the generation time point of the response to the first message; and in response to that the presence of the response message to the first message from the first user is not identified, performing the process at the generation time point of the response to the first message.

According to the other aspect of the present disclosure, there is provided a method for generating AI response using personal data. The method may comprise: obtaining a first message having a first user as a recipient; checking presence of a second message schedule indicating a generation time point of a response to a second message, wherein the second message has the first user as a recipient and is different from the first message; in response to that the presence of the second message schedule is identified, determining whether to add the first message to a response-requesting message set including the second message, based on an analysis result of each of the first message and the second message; and upon determination that the first message is added to the response-requesting message set, performing a process of automatically generating a response message to the response-requesting message set, at a generation time point of a response to the response-requesting message set according to the second message schedule, wherein the generation time point of the response to the response-requesting message set may be a time point delayed by a reference value or greater from a time point at which the second message is obtained, wherein the process may include: retrieving information related to messages included in the response-requesting message set from work information database of an organization to which the first user belongs; automatically generating a first prompt for obtaining a response to each of the messages included in the response-requesting message set, wherein the first prompt includes the retrieved information; transmitting the first prompt to a generative artificial intelligence-based query-response service provider; and receiving the response message from the generative artificial intelligence-based query-response service provider in response to transmission of the first prompt.

In some embodiments, determining whether to add the first message to the response-requesting message set may include: automatically generating a second prompt for determining a relevance level between contents of the second message and contents of the first message; transmitting the second prompt to the generative artificial intelligence-based query-response service provider; receiving an answer from the generative artificial intelligence-based query-response service provider in response to the transmission of the second prompt; determining whether to add the first message to the response-requesting message set based on the answer.

According to the other aspect of the present disclosure, there is provided a method for generating AI response using personal data. The method may comprise: obtaining a first message having a first user as a recipient; retrieving information related to the first message from work information database of an organization to which the first user belongs; automatically generating a first prompt for obtaining a response message to the first message, wherein the first prompt includes the retrieved information; transmitting the first prompt to a first generative artificial intelligence-based query-response service provider; receiving a first answer from the first generative artificial intelligence-based query-response service provider in response to the transmission of the first prompt; and upon determination that contents of the first answer is related to contents of the first message, determining the first answer as the response message.

In some embodiments, automatically generating of the first prompt may include: determining whether the response message can be generated using the retrieved information; and upon determination that the response message can be generated using the retrieved information, automatically generating the first prompt. In some embodiments, In some embodiments, the first prompt may include setting information input from the first user to generate the response message.

In some embodiments, determining of the first answer as the response message may include: automatically generating a second prompt for determining whether the contents of the first answer is related to the contents of the first message; transmitting the second prompt to a second generative artificial intelligence-based query-response service provider; receiving a second answer from the second generative artificial intelligence-based query-response service provider in response to the transmission of the second prompt; and determining whether the contents of the first answer is related to the contents of the first message, based on the second answer.

In some embodiments, retrieving of the information related to the first message from the work information database of the organization to which the first user belongs may include: automatically generating a second prompt for removing a portion not related to a work of the first user from the first message; transmitting the second prompt to the first generative artificial intelligence-based query-response service provider; receiving messages from which the portion not related to the work of the first user has been removed, from the first generative artificial intelligence-based query-response service provider, in response to the transmission of the second prompt; and retrieving information related to the messages from which the portion not related to the work of the first user has been removed from the work information database of the organization to which the first user belongs.

In some embodiments, retrieving of the information related to the first message from the work information database of the organization to which the first user belongs may include: automatically generating a second prompt for extracting a keyword related to a work of the first user from the first message; transmitting the second prompt to the first generative artificial intelligence-based query-response service provider; receiving the keyword related to the work of the first user from the first generative artificial intelligence-based query-response service provider in response to the transmission of the second prompt; and retrieving information related to the received keyword related to the work of the first user from the work information database of the organization to which the first user belongs.

### BRIEF DESCRIPTION OF DRAWINGS

The above and other aspects and features of the present disclosure will become more apparent by describing in detail various embodiments thereof with reference to the attached drawings, in which:

FIG. 1 is a conceptual diagram illustrating an overall configuration of a system for generating an AI-based response using personal data according to an embodiment of the present disclosure;

FIG. 2 is a flowchart illustrating a method for generating an AI-based response using personal data according to an embodiment of the present disclosure;

FIG. 3 is an example diagram specifically illustrating the method for generating the AI-based response using personal data as described with reference to FIG. 2;

FIG. 4 is a flowchart illustrating an example related to a response message generation process as described with reference to FIG. 2;

FIG. 5 is another example diagram specifically illustrating the method for generating the AI-based response using personal data as described with reference to FIG. 2;

FIG. 6 is still another example diagram specifically illustrating the method for generating the AI-based response using personal data as described with reference to FIG. 2;

FIG. 7 is a flowchart illustrating a method for generating an AI-based response using personal data according to another embodiment of the present disclosure;

FIG. 8 is an example flowchart illustrating operation S220 of FIG. 6;

FIG. 9 is an example diagram specifically illustrating the method for generating the AI-based response using personal data as described with reference to FIG. 6;

FIG. 10 is a flowchart illustrating a method for generating an AI-based response using personal data according to still another embodiment of the present disclosure;

FIG. 11 is an example diagram specifically illustrating the method for generating the AI-based response using personal data as described with reference to FIG. 10;

FIG. 12 is an example flowchart illustrating operation S420 of FIG. 10;

FIG. 13 is another example diagram specifically illustrating the method for generating the AI-based response using personal data as described with reference to FIG. 10; and FIG. 14 is a hardware configuration diagram of a computing device for performing a method for generating an AI-based response using personal data according to some embodiments of the present disclosure.

### DETAILED DESCRIPTIONS

First, a definition of each of specific terms used in the present disclosure will be described.

As used in the present disclosure, the term “a user” refers to a person who uses a system, method, and device for generating an AI-based response using personal data (hereinafter, referred to as a system for generating an AI-based response) according to some embodiments of the present disclosure. The user may receive a message via an external system such as a messenger, a mail system, a video conference program, and productivity software, and may generate a response message using the system for generating an AI-based response.

As used in the present disclosure, the term “a sender” refers to a person who transmits a message received by a user. The sender does not necessarily have to use an external network, and may transmit a message via an internal system such as an in-house messenger. In addition, the sender may include a plurality of senders. However, unless otherwise specified, it is assumed that the sender is one sender for convenience of description.

Hereinafter, some embodiments will be described in detail according to the accompanying drawings.

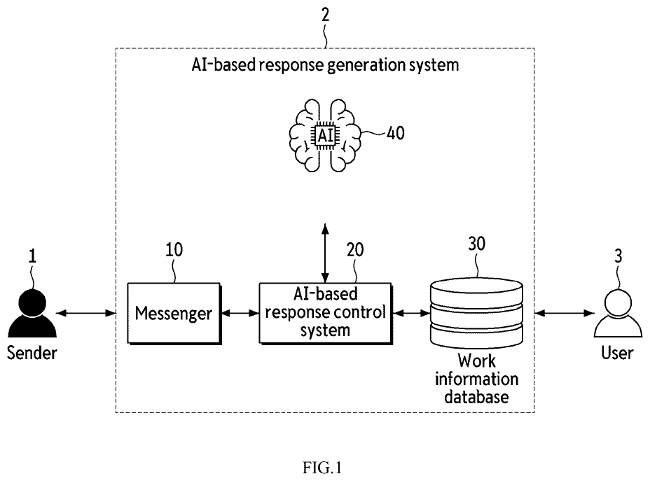

FIG. 1 is a block diagram illustrating an overall configuration of a system for generating an AI-based response using personal data according to an embodiment of the present disclosure. Hereinafter, a configuration of the system for generating an AI-based response using personal data according to the present embodiment will be described with reference to FIG. 1.

As illustrated in FIG. 1, the system for generating an AI-based response (hereinafter, referred to as a response generation system) using personal data according to an embodiment of the disclosure may include a messenger 10, an AI-based response control system 20, work information database 30, and a generative artificial intelligence-based query-response service provider 40. The response generation system 2 may obtain a message from a sender 1, obtain personal data from a user 3, and generate a response message using the obtained message and personal data.

The messenger 10 according to the present disclosure refers to an application or program via which the sender 1 and the user 3 may exchange messages with other in a digital device. For example, the messenger may be an application or program that transmits and receives messages in real time. Further, the messenger may include all software capable of transmitting and receiving messages, such as a mail system, a work communication program, and a chat program. In addition, the messenger may include an in-house messenger that is not connected to the Internet and may be used only on an intranet.

The messenger 10 according to the present disclosure may transmit the message obtained from the sender to the AI-based response control system 20. In addition, the messenger 10 may obtain the AI-based response message from the AI-based response control system 20. In addition, the messenger 10 may display the obtained AI-based response message.

Next, the AI-based response control system 20 refers to a system that generates an AI-based response message in association with at least one of the messenger 10, the work information database 30, and the generative artificial intelligence-based query-response service provider 40.

In addition, the AI-based response control system 20 may control a process of software required to generate the AI-based response message. For example, the AI-based response control system 20 may automatically generate a prompt necessary to generate the AI-based response and transmit the prompt to the generative artificial intelligence-based query-response service provider 40. In addition, the AI-based response control system 20 may obtain information related to a work required to generate an AI-based response from the work information database 30. In addition, the AI-based response control system 20 may generate a message schedule as a time point at which the AI-based response is generated, and the AI-based response control system 20 may execute a process required to generate the AI-based response at the time point indicated by the message schedule.

The work information database 30 refers to work information database of an organization to which a user belongs, including information related to the user's work or data related to the user's work (hereinafter, work-related data). The work information database 30 may include information into which the user stores settings related to an AI-based response (e.g., a work on which AI-based response is available, and an example thereof, a question which AI-based response is available, and an example thereof, AI-based response tone, AI-based response waiting time, and a sender on which AI-based response is available). In addition, the work information database 30 may include a vector database storing therein an vector obtained by embedding the work-related data of the user. For example, the work information database may perform embedding of a user's work-related document, mail, minutes, messages, and the like and store the embedding result therein. In addition, the work information database 30 may not be directly connected to the generative artificial intelligence-based query-response service provider.

In this regard, the work-related data refers to all data necessary for performing work between the user and the sender. For example, the work-related data may include a work-related message, an e-mail, a document, a video conference, and the like. In addition, the work-related data may mean an unprocessed original file or data itself. For example, an original mail, a document file, and video conference recording data may be included in the work-related data.

In addition, the work-related data retrieved from the work information database 30 may be work-related data itself or data only partially extracted from the work-related data. For example, in retrieving the work information database 30 to know the A agenda meeting date, only the document itself related to the A agenda or a portion of the document related to the meeting date (e.g., specific meeting date and time) may be retrieved.

Next, the generative artificial intelligence-based query-response service provider 40 refers to an artificial intelligence service capable of generating various data including text, images, and voices, based on the input prompt. Such a service serves to analyze an input provided from the user, and generate and provide a response suitable for the input. Examples of the generative artificial intelligence-based query-response service provider include ChatGPT, Google Bard, and Microsoft Copilot. However, it should be noted that the generative artificial intelligence-based query-response service provider is not limited to these examples.

The generative artificial intelligence-based query-response service provider 40 according to the present embodiment may receive the prompt from the AI-based response control system 20, generate an answer necessary to generate an AI-based response, and transmit the answer to the AI-based response control system 20.

The components of the system for generating the AI-based response using personal data according to some embodiments of the present disclosure have been described above with reference to FIG. 1. It should be noted that the operations of the components of the system for generating the AI-based response are not limited to the above-described examples, and may include operations related to the AI-based response generation method using personal data according to some embodiments of the present disclosure to be described below. In addition, the technical idea that may be grasped from some embodiments of the present disclosure to be described below may be applied to the above-described system for generating the AI-based response unless otherwise specified.

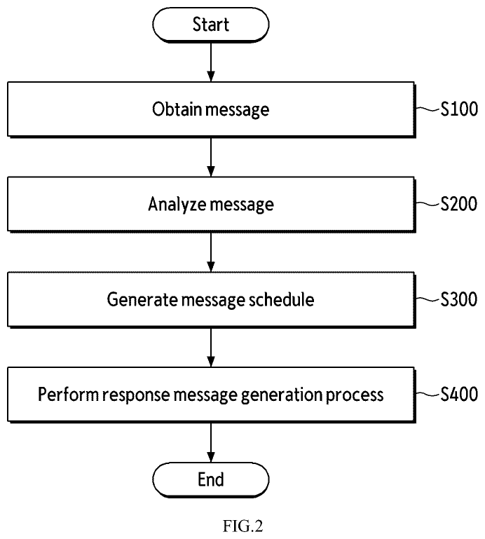

FIGS. 2 to 13 are diagrams illustrating a method for generating an AI-based response using personal data according to some embodiments of the present disclosure (hereinafter, referred to as an AI-based response generation method). Hereinafter, the method for generating the AI-based response according to some embodiments of the present disclosure will be described with reference to FIGS. 2 to 13.

For reference, the AI-based response generation method according to the present embodiment may be performed by one or more computing devices. For example, the AI-based response generation method may be generated by two or more computing devices. Some of the operations included in the AI-based response generation method may be performed by a first computing device, and the remaining ones thereof included in the response generation method may be performed by a second computing device.

For example, the computing device may be the system for generating the AI-based response as described with reference to FIG. 1. In the following description, a subject of a specific step/operation may be omitted, and in this case, it may be understood that the specific step/operation is performed by the computing device.

In addition, it is noted that the embodiments related to the response generation system as described with reference to FIG. 1 may be naturally applied to the response generation method according to the present embodiment unless otherwise specified.

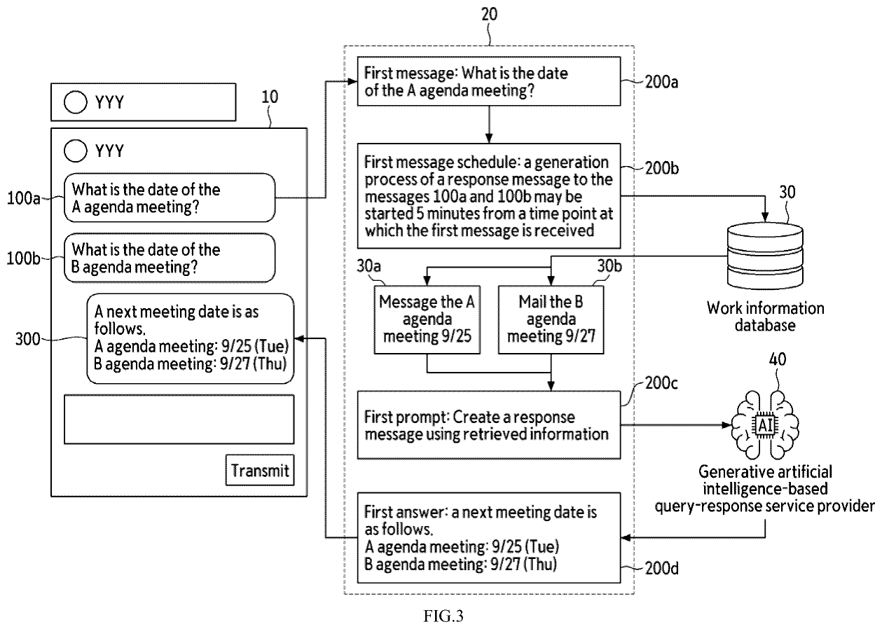

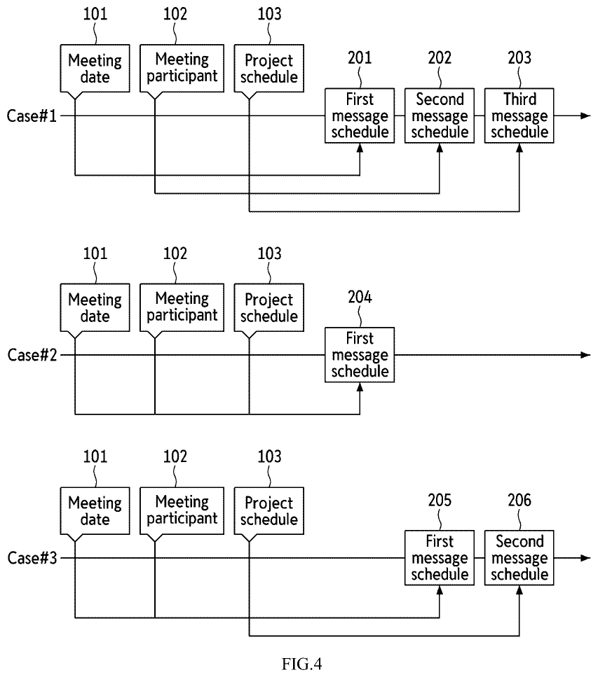

FIG. 2 is a flowchart illustrating a method for generating a response according to an embodiment of the present disclosure. In addition, FIG. 3 is an example diagram specifically illustrating the method for generating the AI-based response using personal data as described with reference to FIG. 2.

Referring to FIG. 2, a first message having the user as a recipient may be obtained in S100. For example, as shown in FIG. 3, the sender YYYY may transmit the first message 100a and 100b such as “What is the date of the A agenda meeting?” 100a and “What is the date of the B agenda meeting?”100b in the messenger.

Next, the first message may be analyzed in S200, and a first message schedule indicating a response generation time point to the first message may be generated using the analysis result of the first message in S300.

In order to describe operations S200 and S300, a basic message schedule will be first described. The message schedule refers to a time point at which a response message to the acquired message is generated. In this regard, the acquired message may be one message or include a plurality of messages. For example, when a message “What will be the meeting date?” is obtained and a message “Who will be the meeting participant?” is obtained immediately thereafter, a response message to the two messages may be generated as one response message at one time point. For example, the response message may be “The meeting date is 10/25, and the meeting participants are XXX, YYY, and ZZZ”. In this case, the plurality of messages are combined with each other and the message schedule about the combined message may be generated.

In operation S200 of FIG. 2, the analysis of the first message may be an analysis for determining whether the first message and a second message are combined with each other and one message schedule about the combined message, or each of the messages schedules corresponding to each of the first and second messages is generated without combining the first message and the second message with each other, when the second message different from the first message is present. Such analysis may be performed based on information related to the message (e.g., a sender of the message, a reception time of the message, and contents of the message).

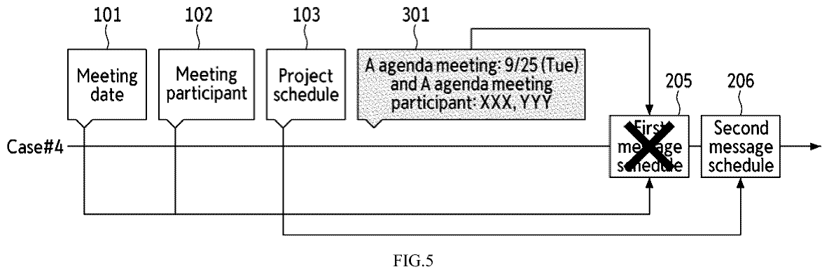

For example, as illustrated in FIG. 4, the message 101 asking for a meeting date as the first message, a message 102 asking for a meeting participant, and a message 103 asking for a project schedule may be obtained. In this regard, the senders of the respective messages are different from each other, and the reception timing of the message 101 is the earliest, the reception timing of the message 102 is the next thereto, and the reception timing of the message 103 is the latest.

For example, as in Case #1 of FIG. 4, a criterion under which the messages are combined with each other and the message schedule about the combined message is generated may be whether the senders of the messages are the same sender. First, the sender of each of the messages may be identified by analyzing each of the messages. Based on a result of the analysis of each of the messages, the senders of the messages are different from each other. In this case, the messages are not combined with each other and individual message schedules may be generated. Accordingly, a first message schedule 201 as a time point at which a response message to the message 101 is generated may be generated, a second message schedule 202 as a time point at which a response message to the message 102 is generated may be generated, and a third message schedule 203 as a time point at which a response message to the message 103 is generated may be generated. According to each of the message schedules, the response message to each of the messages may be generated. That is, a total of three response messages may be generated in the Case #1.

In another example, as in Case #2 of FIG. 4, a criterion under which the messages are combined with each other and the message schedule about the combined message is generated may be whether a message subsequent to the first message has been received within a predetermined time duration from a time point at which the first message is received. First, a reception time point of each of the messages may be identified by analyzing each of the messages. Based on a result of analyzing each of the messages, it may be identified that each of the second message 102 and the third message 103 has been received within the predetermined time duration from the time point at which the first message 101 is received. Accordingly, a first message schedule 204 as a time point at which the combined response message to the first to third messages is generated may be generated. According to the first message schedule 204, a single combined response message to the messages may be generated. That is, in the Case #2, a single response message may be generated.

In still another example, as in Case #3 of FIG. 4, a criterion under which the messages are combined with each other and the message schedule about the combined message is generated may be whether the contents of the messages are similar to each other. First, the contents of each of the messages may be identified by analyzing each of the messages. Based on a result of analyzing each of the messages, the first message 101 and the second message 102 may be identified as the messages related to the meeting, and the third message 103 may be identified as the message related to the project. Accordingly, a first message schedule 205 as a time point at which a combined response message to the first message 101 and the second message 102 is generated may be generated, and a second message schedule 206 as a time point at which a response message to the third message 103 is generated may be generated.

Referring back to FIG. 2, a process (hereinafter, a response message generation process) of automatically generating a response message to a response-requesting message set including the first message and one or more additional messages may be performed at a generation time point of a response to the first message according to the first message schedule in S400.

In this regard, the response-requesting message set may include the first message obtained from a first sender and a second message obtained from the same first sender. That is, a criterion under which the response-requesting message set is constructed may be the sender of the message.

In addition, the response-requesting message set may include the first message obtained from the first sender and a second message obtained from a second sender different from the first sender. That is, the criterion under which the response-requesting message set is constructed may be a criterion (e.g., contents of the message, a reception time point of the message) other than the sender of the message.

For example, as illustrated in FIG. 3, the message 100a asking for a meeting date may be obtained as the first message, and a first message schedule about the first message may be generated (e.g., the response message to the first message may be generated 5 minutes after receiving the first message). In addition, the message 100a asking for a meeting date and an additional message 100b may be determined as constituting one response-requesting message set. In addition, a process of generating a response message to the response-requesting message set 100a and 100b may be performed at a generation time point of a response to the first message according to the first message schedule.

In this regard, determining the two messages as constituting one response-requesting message set may employ the same process as the above-described process executed when the messages are combined with each other and a message schedule to the combined message is generated. That is, when a plurality of messages are combined with each other and the message schedule to the combined message is generated, the plurality of messages to be combined with each other may be determined as constituting one response-requesting message set.

In one example, the time point at which the response to the first message is generated may be a time point delayed by a reference value or larger from the time point at which the first message is acquired. For example, the reference value may be a reference value set in consideration of a time duration for which the user may directly input the response message to the first message. In addition, the reference value may be a response waiting time directly set by the user. When the response message is generated immediately after receiving the first message, there is a possibility that provision of the generated response message may collide with provision of the response message input from the user. Accordingly, the AI-based response starts to be generated at a time point delayed by a preset reference value or larger from the time point at which the message is received, thereby preventing the AI-based response message provision from colliding with the provision of the response message from the user.

In addition, the reference value may be changed without being fixed. For example, the reference value may be changed according to a state on the messenger of the user. When the user is performing another work and does not access the messenger or uses the messenger for a preset time duration or greater, the reference value may be reduced. In this case, the AI-based response may be quickly provided to the sender instead of the user. Conversely, when the user is using the messenger or a current timing is within a preset time duration after using the messenger, the reference value may be increased. When the user is using the messenger or a current timing is within a preset time duration after using the messenger, there is a high possibility that the user directly responds to the message instead of the AI-based response. Thus, the reference value may be increased, thereby preventing a collision between the provision of the AI-based response and the provision of the response from the user.

In addition, in order to reliably prevent the collision between the provision of the AI-based response and the provision of the response from the user, the response message generation process may be performed at a time point delayed by a reference value or greater from a time point at which the first message is acquired, and, furthermore, presence of the response message input by the user may be checked at a timing between the time point at which the first message is acquired and the time point at which the AI-based response is generated. Subsequently, the response message generation process may be performed only when the user does not input the response message. Conversely, when the user inputs the response message, the response message generation process may not be performed.

For example, as illustrated in Case #4 of FIG. 5, the first message schedule 205 as a time point at which the AI-based response message to a combination of the first message 101 and the second message 102 is generated may be not generated, and the second message schedule 206 as a time point at which the AI-based response message to the third message 103 is generated may be generated.

In this regard, when the user directly inputs a response 301 to the combination of the first message 101 and to the second message 102 (e.g., when the user directly inputs the meeting date and the meeting participant), the first message schedule 205 may not be generated. In addition, as the first message schedule 205 is not generated, the response message generation process to the first message 101 and the second message 102 may not be performed at the response generation time point according to the first message schedule 205. In one example, even when the user's response 301 is present, This response is not related to the third message 103, the second message schedule 206 may be generated.

Such an embodiment may reduce the possibility of a collision between the provision of the AI-based response and the provision of the user's response, and consequently, the effect of reducing the fatigue from the AI response experienced by the sender due to the collision between the provision of the AI-based response and the provision of the user's response may be expected.

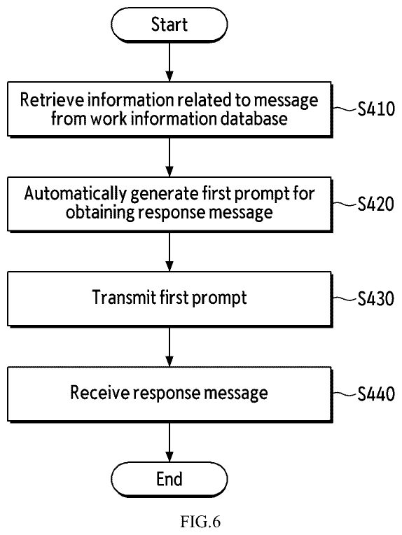

The above-described embodiment of the response message generation process will be described in detail with reference to FIG. 6.

First, information related to the messages included in the response-requesting message set may be retrieved from the work information database of the organization to which the user belongs in S410. For example, as illustrated in FIG. 3, information related to the messages 100a and 100b included in the response-requesting message set may be retrieved from the work information database 30 from the time point at which the response is generated according to the first message schedule. In addition, as a result of the retrieval, a message 30a related to the A agenda meeting from the user and a mail 30b related to the B agenda meeting of the user may be obtained from the work information database 30.

In one example, an update of information related to the first user may be applied to the work information database at a timing between the time point at which the first message is acquired and the generation time point of the response to the first message. For example, when the AI-based response is generated 1 hour after the time point at which the first message is obtained, the AI-based response may be generated by additionally referring to an additional message, an email, a document, and the like related to the user's work as obtained for 1 hour.

In this embodiment, the service provider 40 may generate the AI-based response based on the updated work information database at the time point of generating the response to the first message. As a result, the effect of generating a more accurate AI-based response based on the latest data may be achieved.

Referring back to FIG. 6, a first prompt for obtaining the response to each of the messages included in the response-requesting message set may be automatically generated in S420. In this regard, the first prompt may include the retrieved information. For example, as illustrated in FIG. 3, a first prompt 200c including a text “Create a response message using the retrieved information”and the message 30a and the mail 30b may be automatically generated.

In this regard, the first prompt may include a preset phrase. For example, the first prompt may include an indication to make an answer only using the retrieved information. In addition, the first prompt may include an indication to make an answer except for inaccurate or guessed response. In addition, the first prompt may include an indication to make an answer so as not to repeatedly make the same answer. In addition, the first prompt may include an indication to make an answer in the same language as the language of the query. In addition, the first prompt may include an example of an appropriate answer.

Returning to FIG. 6 again, the first prompt may be transmitted to the generative artificial intelligence-based query-response service provider 40 in S430. Subsequently, the response message may be received from the generative artificial intelligence-based query-response service provider in response to the transmission of the first prompt in S440. For example, the AI-based response control system 20 may transmit the first prompt 200c to the generative AI-based query-response service provider 40 and receive a first answer 200d in response thereto. It may be appreciated that the system 2 for generating the AI-based response has generated the response message by the AI-based response control system 20 receiving the first answer 200d. Such a response message may be immediately displayed on the messenger or may be displayed on the messenger after an additional process.

The method for generating the AI-based response using personal data according to an embodiment of the present disclosure has been described above with reference to FIGS. 2 to 6. The response generation method according to the present disclosure may generate the single combined response message to the plurality of messages, thereby reducing a processing time of the generative artificial intelligence used for generating the response message. Accordingly, the generation speed of the AI-based response may be improved.

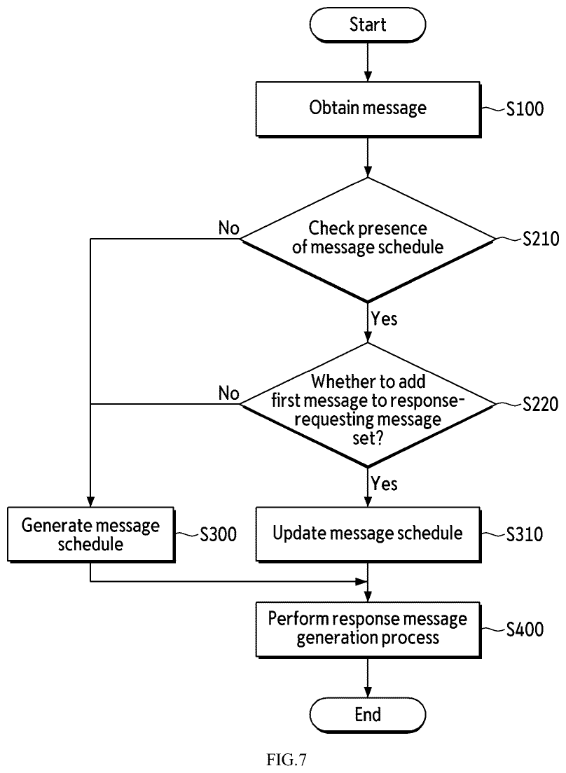

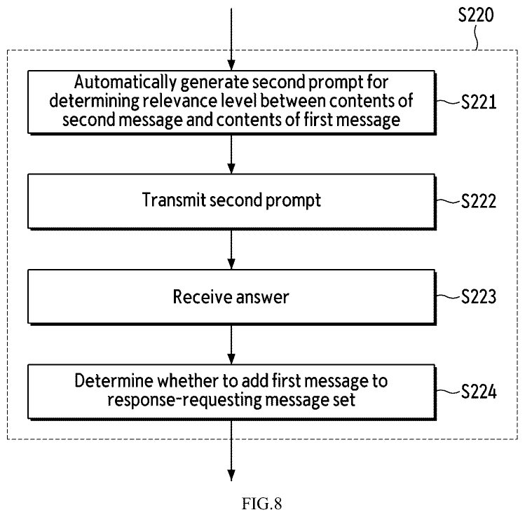

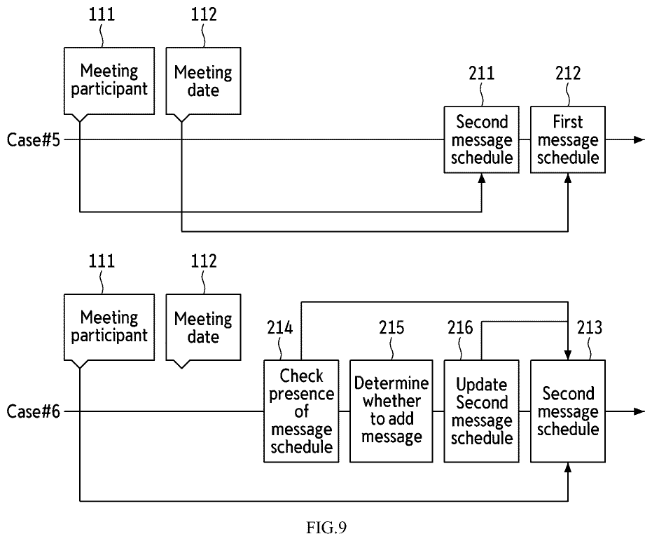

FIGS. 7 and 8 are diagrams illustrating a response generation method in which an existing message schedule is updated, unlike the response generation method according to the above-described embodiment. Hereinafter, the method for generating the AI-based response according to another embodiment of the present disclosure will be described with reference to FIGS. 7 and 8.

First, a first message having the user as a recipient may be obtained in S100. In this regard, obtaining the first message may mean that the sender inputs a message on the messenger, the user receives the message, and the system for generating the AI-based response of the present disclosure stores data on the message. Subsequently, presence of a second message schedule indicating a response generation time point to a second message different from the first message and having the user as the recipient may be checked in S210.

For example, as in Case #6 of FIG. 9, the first message may be a message 112 asking for a meeting date, and the second message may be a message 111 asking for a meeting participant. In this regard, the second message schedule 213 indicating the time point at which the response to the second message is generated may have already been generated. When there is no second message schedule presence checking procedure according to the present embodiment, the first message schedule may be generated as in Case #5 of FIG. 9. However, in the present embodiment, the second message schedule may be updated without generating the first message schedule.

Referring back to FIG. 7, in response to that the presence of the second message schedule has been identified, whether to add the first message to the response-requesting message set including the second message may be determined using the analysis result of the first message and the second message in S220.

In this regard, whether to add the first message to the response-requesting message set including the second message may be determined according to a preset condition.

For example, when the first message is received at a time point delayed by a reference value or greater from a time point at which the second message is received, the first message may not be added to the response-requesting message set. In this case, the AI-based response is generated immediately after receiving the first message, such that there is a possibility that the provision of the AI-based response and the provision of the user's response may collide with each other.

In another example, when the contents of the second message is different from the contents of the first message, the first message may not be added to the response-requesting message set. In this case, it is necessary to retrieve information related to both the first message and the second message and generate the response thereto, such that the response generation to the second message received earlier than the first message may be delayed. In addition, the generated responses should include answers not related to each other, such that there is a possibility that the accuracy of the response may deteriorate.

In order to solve the above problem, in the present embodiment, the message schedule may be unconditionally updated even when the presence of the second message schedule is identified, so that the response to the first message and the response to the second message are not generated at the same time. Only upon determination that it is appropriate to generate the response to the first message and the response to the second message at the same time, both the responses may be generated at the same time. That is, in the process according to the present embodiment, when the existing message schedule is not updated, a new message schedule may be generated. A detailed example of the present embodiment will be described in detail with reference to FIG. 8.

Referring back to FIG. 7, when the first message is added to the response-requesting message set, the second message schedule may be updated in S310. In this regard, updating the message schedule means changing the second message schedule to generate a response message to the response-requesting message set including the first message and the second message at the response generation time according to the second message schedule without newly generating the first message schedule indicating the response generation time to the first message.

Next, a process of automatically generating a response message to the response-requesting message set is performed at a response generation time to the response-requesting message set according to the second message schedule in S400. In this regard, the process of automatically generating the response message is the same as the process of generating the response message as described above, and the description thereof will be omitted.

Hereinabove, the method for generating the response according to an embodiment of the disclosure has been described above with reference to FIG. 7. It should be noted that when the message schedule is not updated according to the present embodiment, a new message schedule may be generated in S300. For example, the case in which the message schedule is not updated may be a case in which presence of the existing message schedule is not identified and the first message is not added to the response-requesting message set. FIG. 8 is an example flowchart illustrating operation S220 as described with reference to FIG. 7. Hereinafter, operation S220 will be described with reference to FIG. 8.

In an embodiment, determining whether to add the first message to the response-requesting message set including the second message may be determined based on a relevance level between the contents of the first message and the contents of the second message.

Specifically, a second prompt for determining the relevance level between the contents of the second message and the contents of the first message may be automatically generated in S221. For example, the second prompt may be automatically generated, such as “Determine whether the contents of the second message of the identified message schedule and the contents of the received first message are related to the same work”.

Subsequently, the second prompt may be transmitted to the generative artificial intelligence-based query-response service provider in S222, and a second answer may be received from the generative artificial intelligence-based query-response service provider in response to the transmission of the second prompt in S223. For example, a following second answer may be received: “Both the first and second messages are related to the A agenda meeting. The first message is a message asking the date of the meeting, and the second message is a message asking the participant of the meeting.”.

Subsequently, based on the second answer, whether to add the first message to the response-requesting message set may be determined in S224. For example, a condition that “if the first message and the second message are related to the same work, the first message is added to the response-requesting message set including the second message” may be preset. In this case, when the first and second messages are related to the same work (e.g., A agenda meeting), the first message may be added to the response-requesting message set including the second message.

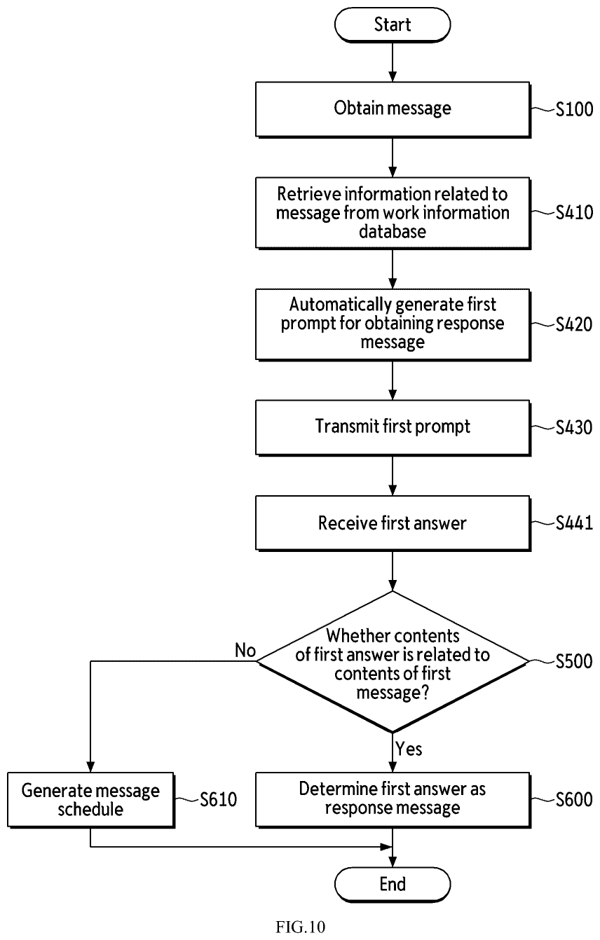

In the hereinabove, operation S220 of the response generation method according to an embodiment of the present disclosure has been described above with reference to FIG. 8. FIGS. 10 to 13 are diagrams illustrating a response generation method according to another embodiment of the present disclosure. Hereinafter, a method for generating a response according to another embodiment of the present disclosure will be described with reference to FIGS. 10 to 13.

FIG. 10 is a flowchart illustrating a method for generating a response according to an embodiment of the disclosure. The present embodiment relates to a method for checking whether an answer obtained from a generative artificial intelligence-based query-response service provider matches a message obtained from a sender in order to check whether an AI-based response matches a user's intention.

First, a first message having the user as a recipient may be obtained in S100. In this regard, the first message is at least one message received from at least one or more senders. That is, the technical idea to be described later may also be applied to the above-described response-requesting message set.

Subsequently, information related to the first message may be retrieved from the work information database of the organization to which the first user belongs in S410. Subsequently, a first prompt for obtaining a response message to the first message may be automatically generated, and the first prompt may include retrieved information in S420. The first prompt may be transmitted to the generative artificial intelligence-based query-response service provider in S430. That is, operations S410 to S430 according to the present embodiment may be the same as some operations of the response generation process described above.

In an embodiment, the first prompt may include setting information input by the user to generate the response message. In this regard, the setting information may be information that is constantly applied to the first prompt regardless of the message, unlike the information retrieved from the work information database that varies according to the message.

For example, the setting information may be a type of a work (e.g., A project, B meeting) related to a response that may be generated by the system for generating the AI-based response. In another example, the setting information may be information related to a tone for uttering the AI-based response (e.g., a hard office tone, a friendly tone using an emoticon, a tone answering only the core contents, and a tone explaining in maximum detail). In another example, the setting information may be information related to a question that can be answered by the system for generating the AI-based response (e.g., a keyword of a question that can be answered, an example of a question that can be answered). In still another example, the setting information may be information related to a sender to which the system for generating the AI-based response may respond (e.g., a sender list of senders to which the AI-based response can be provided, a sender list of senders to which the AI-based response cannot be provided).

Subsequently, a first answer may be received from the first generative artificial intelligence-based query-response service provider in response to the transmission of the first prompt in S441. In this regard, it should be noted that the first answer is not immediately determined as the response message to the first message.

Subsequently, it may be determined whether the contents of the answer is related to the contents of the first message in S500. For example, when the contents of the answer (e.g., a specific meeting date, a meeting participant, a meeting agenda) may be an answer to a question (e.g., a question asking information about a meeting) included in the first message, the contents of the answer and the contents of the first message may be related to each other. In addition, when the contents of the answer satisfies the user's intention to respond to the first message, the contents of the answer is related to the contents of the first message.

When it is determined that the contents of the answer is related to the contents of the first message, the first answer may be determined as the response message in S600. In one example, when it is determined that the contents of the answer and the contents of the first message are not related to each other, a response message indicating that the answer is not available instead of the first answer may be generated in S610.

In this regard, determining whether the contents of the answer is related to the contents of the first message may include determining whether the contents of the answer is related to the contents of the first message using the generative artificial intelligence-based query-response service provider 40.

Specifically, a second prompt for determining whether the contents of the answer is related to the contents of the first message may be automatically generated. Subsequently, the second prompt may be transmitted to the second generative artificial intelligence-based query-response service provider 40. Subsequently, a second answer may be received from the second generative artificial intelligence-based query-response service provider 40 in response to the transmission of the second prompt. Subsequently, whether the contents of the first answer is related to the contents of the first message may be determined using the second answer.

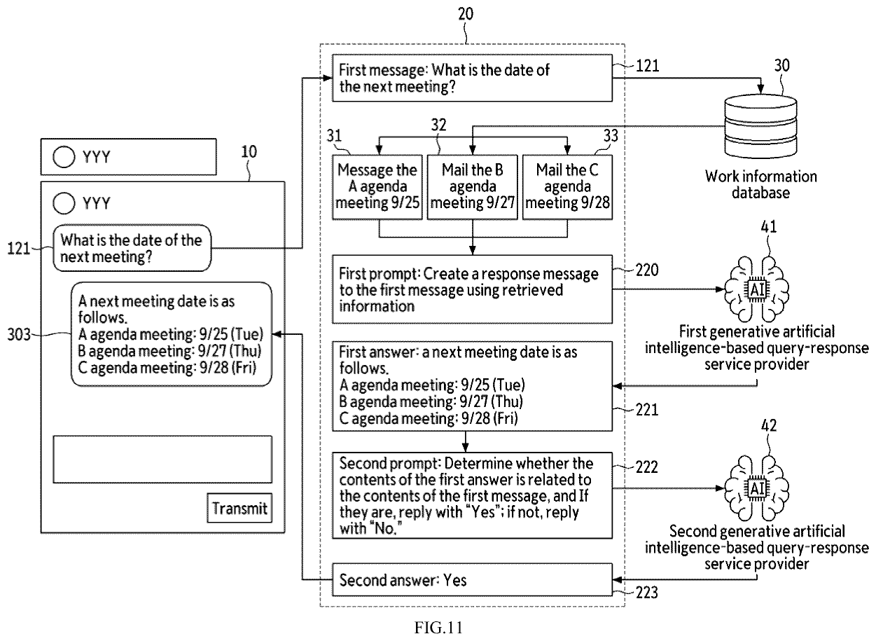

A detailed example of the present embodiment described above with reference to FIG. 10 will be described with reference to FIG. 11.

As shown in FIG. 11, a first message 121 with the contents “What is the next meeting date?” may be obtained from the messenger 10. Subsequently, information related to the first message 121 may be retrieved from the work information database 30. As a result of the retrieval, a message 31, a mail 32, and a document 33 may be obtained. Subsequently, a first prompt 220 including the retrieved information and the text “Write a response message to the first message using the retrieved information”may be automatically generated.

Next, the first prompt 220 may be transmitted to a first generative artificial intelligence-based query-response service provider 41. Subsequently, the first generative artificial intelligence-based query-response service provider 41 may generate and transmit a first answer 221 indicating the date of each meeting in response to the first prompt 220.

Next, a second prompt 222 for determining whether the contents of the first answer 221 is related to the contents of the first message 121 may be automatically generated. The second prompt 222 may then be transmitted to a second generative artificial intelligence-based query-response service provider 42. Subsequently, the second generative artificial intelligence-based query-response service provider 42 may generate and transmit a second answer that determines whether the contents of the first answer 221 is related to the contents of the first message 121 in response to the second prompt 222.

As illustrated in FIG. 11, the second generative artificial intelligence-based query-response service provider 42 determines that both the contents of the first answer 221 and the contents of the first message 121 are about the meeting date, and thus are related to each other. Thus, the first answer 221 may be determined as a response message to the first message 121.

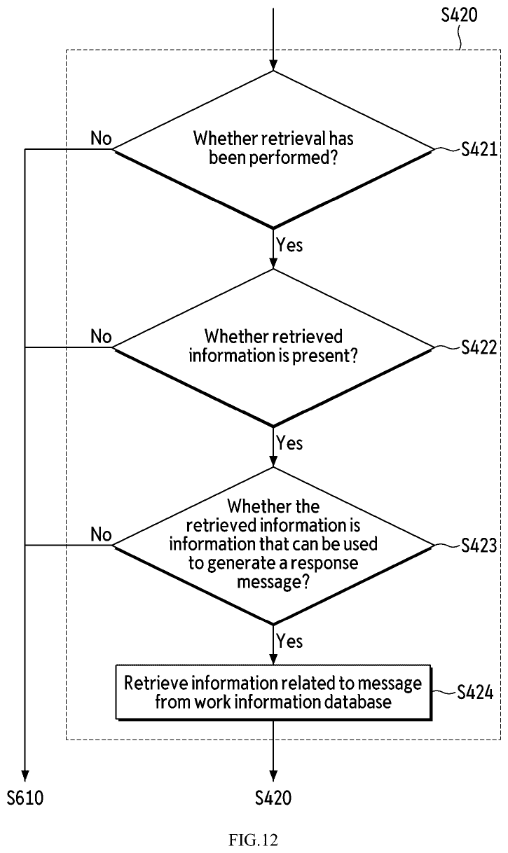

In the hereinabove, the method for generating the AI-based response according to an embodiment of the present disclosure has been described above with reference to FIGS. 10 and 11. FIG. 12 is a flowchart illustrating operation S420 as described with reference to FIG. 10. Hereinafter, operation S420 will be described with reference to FIG. 12.

Operation S420 as described with reference to FIG. 10 may include determining whether the retrieval has been performed, whether retrieved information is present, and whether the retrieved information is available.

Specifically, it may be determined whether the response message can be generated using the retrieved information. Specifically, it may be determined whether the retrieval has been performed in S421. When the retrieval is not performed due to an error, it is impossible to generate an AI-based response using personal data. In this case, a response message indicating that an answer is not available without generating a prompt may be generated.

In addition, it may be determined whether the retrieved information is present in S422. Even when information retrieval from the work information database has been performed, the retrieved information may be absent. In this case, it is impossible to generate an AI-based response using personal data. Thus, a response message indicating that an answer is not available without generating a prompt may be generated.

In addition, it may be determined whether the retrieved information is information that can be used to generate a response message in S423. Even when the information retrieval from the work information database has been performed and the retrieved information is present, the retrieved information may not be used to generate a response. For example, information that should be present only in the work information database for security reasons, information excluded from being used for response generation because it includes incorrect data, information that the sender does not have authority to check, and the like may be included in information that may not be used for response generation.

After the above-described operations, it is determined that the retrieval has been performed, the retrieved information is present, and the retrieved information is information that may be used to generate a response message. In this case, the first prompt including the retrieved information may be automatically generated in S424.

According to the present embodiment, when a response message cannot be generated using the retrieved information, a response message indicating that an answer is not available may be generated instead of the response message. In the present embodiment, a situation in which an incorrect response may be generated may be prevented, and as a result, it may be expected to provide an effect of reducing fatigue from the AI-based response and improving reliability.

In one example, retrieving the information related to the first message from the work information database using the first message directly may consume a lot of time and inefficiently use computational resources. Accordingly, for efficient database retrieval, it is requested to provide a technology for processing the first message.

In an embodiment, retrieving the information related to the first message from the work information database of the organization to which a first user belongs may include removing a portion not related to the work from the first message and retrieving the information related to the first message from the work information database.

Specifically, a second prompt for removing a portion (e.g., greeting, thank you, exclamation, name, title, and daily conversation) not related to the work of the first user from the first message may be automatically generated. Subsequently, the second prompt may be transmitted to the generative artificial intelligence-based query-response service provider. Subsequently, in response to the transmission of the second prompt, messages in which the portion not related to the user's work has been removed may be received from the generative artificial intelligence-based query-response service provider. Subsequently, information related to the messages from which the portion not related to the user's work has been removed may be retrieved from the work information database of the organization to which the first user belongs.

That is, the portion not related to a work is removed from the message, and then, the AI-based response may be generated based on the message including the portion related to the work.

Moreover, retrieving the information related to the first message from the work information database of the organization to which the first user belongs may include extracting a keyword related to a work from the first message and retrieving information related to the extracted keyword from the first message from the work information database.

First, a second prompt for extracting the keyword (e.g., contents included in a question, contents included in a request, a project schedule, a meeting date, and matters related to outsourcing) related to a user's work from the first message may be automatically generated. Subsequently, the second prompt may be transmitted to the generative artificial intelligence-based query-response service provider. Subsequently, in response to the transmission of the second prompt, a keyword related to the work of the first user may be received from the generative artificial intelligence-based query-response service provider. Subsequently, information related to the received keyword related to the work of the first user may be retrieved from the work information database of the organization to which the first user belongs.

That is, only the keyword related to the work may be extracted from the message, and information related to the extracted keyword may be retrieved from the work information database.

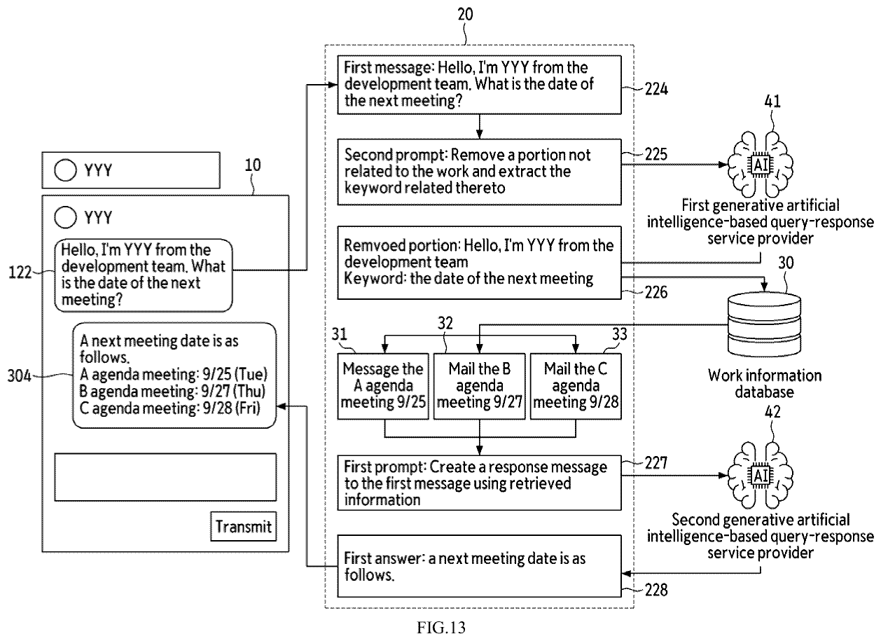

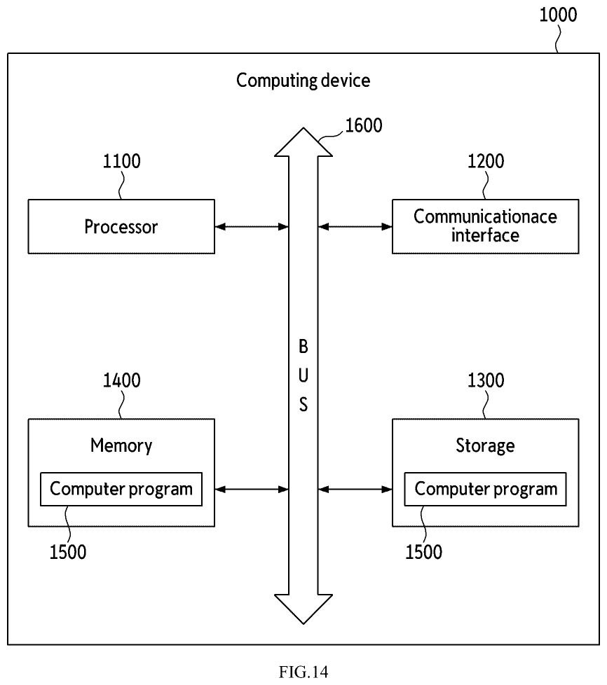

The two embodiments as described above may be applied individually or in a combination with each other. Hereinafter, an example in which two embodiments are applied in combination with each other will be described with reference to FIG. 13.

First, the first message 122 “Hello, I'm YYY from the development team. “What is the next meeting date?” may be obtained. In this regard, the portion of “Hello, I'm YYY from the development team.” is not related to the work, and the keyword may be “meeting date”.

Subsequently, the second prompt 225 for removing the portion not related to the work and extracting the keyword may be automatically generated. In addition, the second prompt 225 may be transmitted to the first generative artificial intelligence-based query-response service provider 41. In addition, the first generative AI-based query-response service provider 41 may, in response to the second prompt 225, remove the portion related to the work from the message, extract the keyword 226 from the message, and transmit the extracted keyword to the AI-based response control system 20.

Then, using the extracted keyword 226, information 31, 32, and 33 related to the first message 122 may be retrieved from the work information database. A first prompt 227 including the retrieved information and instructing generating of the response message may be automatically generated. The first prompt 227 may be transmitted to the second generative AI-based query-response service provider 42. A first answer 228 including contents informing the meeting date may be received from the second generative AI-based query-response service provider 42. In this regard, the first answer may be determined as a response message 304 to the first message according to a preset condition.

In the hereinabove, the response generation method and the system for executing the method have been described. The generative artificial intelligence-based query-response service provider as mentioned in the above description may be the same for all prompts, and may be different for different prompts.

When the same artificial intelligence-based query-response service provider is used for all prompts, consistency in the quality of the answer received from the artificial intelligence-based query-response service provider may be maintained. In addition, an efficient answer may be generated by fine-tuning the artificial intelligence-based query-response service provider based on work-related data. In addition, the service provider may easily track and associate previous answers with each other, so that the system may be managed in an integrated manner without the need to collect data separately for each of the prompts.

When different artificial intelligence-based query-response service providers are used for different prompts, more specialized answers may be provided. For example, when a portion that is not related to the work is removed from a sender's message or the keyword is extracted therefrom, the artificial intelligence-based query-response service provider having excellent inference capability may be used. In addition, when the response message is generated based on work-related data, the artificial intelligence-based query-response service provider having excellent expression ability may be used. In addition, when a problem occurs or performance degradation occurs in a specific artificial intelligence-based query-response service provider, another artificial intelligence-based query-response service provider may be used to reduce dependence on one service provider and lower a risk.

The method for generating an AI-based response according to some embodiments of the present disclosure may generate a single AI-based response to a combination of the plurality of messages instead of immediately generating respective AI-based responses to the plurality of messages. Accordingly, there is no need to consume a separate artificial intelligence operation resource on each of the messages, and unnecessary waste of operation resources may be prevented. In addition, the AI-based response generation method according to some embodiments of the present disclosure may generate the response based on a result of simultaneously considering the plurality of messages, thereby achieving an effect of generating a more accurate AI-based response.

In addition, the AI-based response generation method according to some embodiments of the present disclosure may determine the accuracy of the AI-based response. This may prevent a hallucination problem caused by generating the AI-based response including information that is not real or irrelevant to the fact. As a result, the reliability and accuracy of the AI-based response may be improved to provide more consistent information, and unnecessary errors may be minimized.

In addition, the AI-based response generation method according to some embodiments of the present disclosure may include a AI-based response generation method using a knowledge-based retrieval. The AI-based response using the knowledge-based retrieval may inevitably decrease the operation speed in order to increase accuracy. Hoover, the method for generating the AI-based response according to some embodiments of the present disclosure may provide an optimized processing scheme of the knowledge retrieval capable of maintaining high accuracy while minimizing such a decrease in the operation speed. This may enable rapid and reliable AI-based response generation to improve the overall performance of the system for generating the AI-based response.

The effects according to the technical idea of the present disclosure are not limited to the above-mentioned effects, and other effects not mentioned may be clearly understood by a person skilled in the art from the contents of the present disclosure.

Hereinafter, a hardware configuration of an example computing device according to some embodiments of the present disclosure will be described with reference to FIG. 14. The computing device may be a computing device in which the system 2 for generating the AI-based response of the present disclosure or some components of the system operates.

FIG. 14 is an example hardware configuration diagram capable of implementing a computing device in various embodiments of the present disclosure. The computing device 1000 according to the present embodiment may include one or more processors 1100, a system bus 1600, a communication interface 1200, a memory 1400 for loading a computer program 1500 executed by the processor 1100 thereon, and storage 1300 storing the computer program 1500 therein. FIG. 14 illustrates only components related to an embodiment of the present disclosure. Accordingly, those skilled in the art to which the present disclosure belongs may appreciate that the computing device further includes general-purpose components other than the components shown in FIG. 14.

The processor 1100 controls the overall operation of each of the components of the computing device 1000. The processor 1100 may include at least one of a central processing unit (CPU), a micro processor unit (MPU), a micro controller unit (MCU), a graphic processing unit (GPU), or any type of processor well known in the technical field of the present disclosure. In addition, the processor 11100 may perform an operation on at least one application or program for executing a method/operation according to various embodiments of the disclosure. The computing device 1000 may include two or more processors.

The memory 1400 stores therein various contents, commands, and/or information. The memory 1400 may load, thereon, one or more programs 1500 from the storage 1300 to execute methods/operations according to various embodiments of the present disclosure. An example of the memory 1400 may be RAM, but is not limited thereto. The system bus 1600 provides a communication function between components of the computing device 1000.

The system bus 1600 may be implemented as various types of buses such as an address bus, a data bus, and a control bus. The communication interface 1200 supports wired/wireless Internet communication of the computing device 1000. The communication interface 1200 may support various communication schemes other than Internet communication. To this end, the communication interface 1200 may be configured to include a communication module well known in the technical field of the present disclosure. The storage 1300 may non-temporarily store therein one or more computer programs 1500. The storage 1300 may include a non-volatile memory such as a flash memory, a hard disk, a removable disk, or any form of computer-readable recording medium well known in the art to which the present disclosure pertains.

The computer program 1500 may include one or more instructions using which methods/operations according to various embodiments of the present disclosure are implemented. When the computer program 1500 is loaded into the memory 1400, the processor 1100 may execute the one or more instructions to perform methods/operations according to various embodiments of the present disclosure.

Although the operations are shown in a particular order in the drawings, it should not be understood that the operations should be executed in the particular order shown or in a sequential order, or that all illustrated operations should be executed to obtain the desired result. In certain situations, multi-tasking and parallel processing may be advantageous. Moreover, it should be not understood that when the various components in the embodiments described above are separate from each other, this separation is essential. It may be appreciated that the described program components and systems may generally be integrated together into a single software product or packaged into multiple software products.

Although the embodiments of the present disclosure have been described above with reference to the accompanying drawings, the present disclosure is not limited to the above embodiments, but may be implemented in various different forms. A person skilled in the art may appreciate that the present disclosure may be practiced in other concrete forms without changing the technical spirit or essential features of the present disclosure. Therefore, it should be appreciated that the embodiments as described above are not restrictive but illustrative in all respects.

What is claimed is:

1. A method for generating AI-based response using personal data, the method being performed by a computing device, the method comprising:
obtaining a first message having a first user as a recipient;
generating a first message schedule indicating a generation time point of a response to the first message, based on an analysis result of the first message; and
performing a process of automatically generating a response message to a response-requesting message set, at the generation time point of the response to the first message according to the first message schedule, wherein the response-requesting message set includes the first message and one or more additional messages,
wherein the generation time point of the response to the first message is a time point delayed by a reference value or larger from a time point at which the first message is acquired,
wherein the process includes:
retrieving information related to the one or more additional messages included in the response-requesting message set from work information database of an organization to which the first user belongs;
automatically generating a first prompt to obtain a response to each of the one or more additional messages included in the response-requesting message set, wherein the first prompt includes the retrieved information;
transmitting the first prompt to a generative artificial intelligence-based query-response service provider; and
receiving the response message from the generative artificial intelligence-based query-response service provider in response to transmission of the first prompt.

2. The method of claim 1, wherein an update of information related to the first user has been applied to the work information database, at a time point between a time point at which the first message is acquired and the generation time point of the response to the first message.

3. The method of claim 1, wherein the response-requesting message set includes a second message obtained from a sender of the first message.

4. The method of claim 1, wherein the response-requesting message set includes a second message obtained from a sender different from the sender of the first message.

5. The method of claim 1, wherein the performing of the process includes:
checking presence of a response message to the first message from the first user at a time point between a time point at which the first message is obtained and the generation time point of the response to the first message; and
in response to that the presence of the response message to the first message from the first user is not identified, performing the process at the generation time point of the response to the first message.

6. A method for generating AI-based response using personal data, the method being performed by a computing device, the method comprising:
obtaining a first message having a first user as a recipient;
checking presence of a second message schedule indicating a generation time point of a response to a second message, wherein the second message has the first user as a recipient and is different from the first message;
in response to that the presence of the second message schedule is identified, determining whether to add the first message to a response-requesting message set including the second message, based on an analysis result of each of the first message and the second message; and
upon determination that the first message is added to the response-requesting message set, performing a process of automatically generating a response message to the response-requesting message set, at a generation time point of a response to the response-requesting message set according to the second message schedule,
wherein the generation time point of the response to the response-requesting message set is a time point delayed by a reference value or greater from a time point at which the second message is obtained,
wherein the process includes:
retrieving information related to messages included in the response-requesting message set from work information database of an organization to which the first user belongs;
automatically generating a first prompt for obtaining a response to each of the messages included in the response-requesting message set, wherein the first prompt includes the retrieved information;
transmitting the first prompt to a generative artificial intelligence-based query-response service provider; and
receiving the response message from the generative artificial intelligence-based query-response service provider in response to transmission of the first prompt.

7. The method of claim 6, wherein the determining whether to add the first message to the response-requesting message set includes:
automatically generating a second prompt for determining a relevance level between contents of the second message and contents of the first message;
transmitting the second prompt to the generative artificial intelligence-based query-response service provider;
receiving an answer from the generative artificial intelligence-based query-response service provider in response to the transmission of the second prompt;
determining whether to add the first message to the response-requesting message set based on the answer.

8. A method for generating AI-based response using personal data, the method being performed by a computing device, the method comprising:
obtaining a first message having a first user as a recipient;
retrieving information related to the first message from work information database of an organization to which the first user belongs;
automatically generating a first prompt for obtaining a response message to the first message, wherein the first prompt includes the retrieved information;
transmitting the first prompt to a first generative artificial intelligence-based query-response service provider;
receiving a first answer from the first generative artificial intelligence-based query-response service provider in response to the transmission of the first prompt; and
upon determination that contents of the first answer is related to contents of the first message, determining the first answer as the response message.

9. The method of claim 8, wherein the automatically generating of the first prompt include:
determining whether the response message can be generated using the retrieved information; and
upon determination that the response message can be generated using the retrieved information, automatically generating the first prompt.

10. The method of claim 8, wherein the first prompt includes setting information input from the first user to generate the response message.

11. The method of claim 8, wherein the determining of the first answer as the response message includes:
automatically generating a second prompt for determining whether the contents of the first answer is related to the contents of the first message;
transmitting the second prompt to a second generative artificial intelligence-based query-response service provider;
receiving a second answer from the second generative artificial intelligence-based query-response service provider in response to the transmission of the second prompt; and
determining whether the contents of the first answer is related to the contents of the first message, based on the second answer.

12. The method of claim 8, wherein the retrieving of the information related to the first message from the work information database of the organization to which the first user belongs includes:
automatically generating a second prompt for removing a portion not related to a work of the first user from the first message;
transmitting the second prompt to the first generative artificial intelligence-based query-response service provider;
receiving messages from which the portion not related o the work of the first user has been removed, from the first generative artificial intelligence-based query-response service provider, in response to the transmission of the second prompt; and
retrieving information related to the messages from which the portion not related to the work of the first user has been removed from the work information database of the organization to which the first user belongs.

13. The method of claim 8, wherein the retrieving of the information related to the first message from the work information database of the organization to which the first user belongs includes:
automatically generating a second prompt for extracting a keyword related to a work of the first user from the first message;
transmitting the second prompt to the first generative artificial intelligence-based query-response service provider;
receiving the keyword related to the work of the first user from the first generative artificial intelligence-based query-response service provider in response to the transmission of the second prompt; and
retrieving information related to the received keyword related to the work of the first user from the work information database of the organization to which the first user belongs.
